(19) United States
(12) Patent Application Publication
(10) Pub. No.: US 2024/0034633 A1
(43) Pub. Date: Feb. 1, 2024

(54) PROCESS FOR PRODUCING PHOSGENE BY REACTION OF POLYCHLORINE ANIONS AND CARBON MONOXIDE

(71) Applicant: Covestro Deutschland AG, Leverkusen (DE)

(72) Inventors: Sivathmeehan Yogendra, Düsseldorf (DE); Sebastian Hasenstab-Riedel, Berlin (DE); Rainer Weber, Odenthal (DE); Patrick Vossnacker, Berlin (DE); Yuliya Schiesser, Troisdorf (DE); Simon Steinhauer, Berlin (DE); Thomas Keilhack, Berlin (DE)

(21) Appl. No.: 18/256,961

(22) PCT Filed: Dec. 13, 2021
(86) PCT No.: PCT/EP2021/085548

§ 371 Date: Jun. 12, 2023

(30) Foreign Application Priority Data
Dec. 14, 2020 (EP) 20213933.3

(51) Int. Cl. C01B 32/80

(52) U.S. Cl. CPC C01B 32/80

(57) ABSTRACT

A process comprising at least the steps a) providing a reaction space containing a component including at least one polychlorine anion-containing compound, preferably at least one polychlorine anion-containing compound in the form of an ionic liquid, b) contacting carbon monoxide with said component in the reaction space and there reacting the carbon monoxide to form phosgene-containing product, c) optionally collecting the phosgene from the phosgene-containing product of step b), d) optionally reacting the phosgene from the phosgene-containing product of step b) or the collected phosgene from step c) with a phosgene-reactive component, makes it possible to prepare, in step b), a phosgene-containing product which contains less than 5.0% by weight of Cl₂ base on its total weight.

The invention relates to a process for producing phosgene and to compositions which are used in the process according to the invention and in the embodiments thereof.

Phosgene is usually produced industrially by reacting chlorine gas and carbon monoxide gas at elevated temperatures over a specific activated carbon catalyst, using energy, for example to cool the reaction zone and increase the temperature.

The handling of the toxic and highly corrosive chlorine gas for phosgene production is complex. For instance, the chlorine gas container (high-pressure gas cylinder) requires a specially designated storage location that is subject to certain regulations. The high-pressure gas cylinders filled with chlorine gas are under such high gas pressure of typically about 7 bar that they require special gas pressure reducers for the removal of chlorine gas. In addition, corrosion-resistant gas lines and a device for quenching the excess chlorine gas are required. It was therefore an object of the present invention to provide a process for the formation of phosgene for the direct further processing of phosgene which facilitates handling of the reactants.

Direct phosgene synthesis from chlorine gas and carbon monoxide over activated charcoal as catalyst is highly exothermic (−107.6 kJ/mol), so that the installation of an intensive reaction heat removal system is inevitably necessary. It was therefore an object of the present invention to provide a process for the formation of phosgene for the direct further processing of phosgene which manages without or with reduced removal of heat of reaction.

The conversion of chlorine gas and carbon monoxide necessarily requires the use of an additional activated carbon catalyst. For this purpose, laboriously filled, specially manufactured tubular reactors equipped with activated carbon are classically used on an industrial scale. It was therefore an object of the present invention to develop a process for the formation of phosgene for the direct further processing of phosgene that does not require such an activated carbon catalyst.

Direct phosgene synthesis from chlorine gas and carbon monoxide is not classically carried out on a laboratory scale. If smaller amounts of phosgene, i.e. less than 10 g, are to be used, for example for chemical reactions with phosgene as reactant on a laboratory scale and this phosgene is to be produced directly by means of phosgene synthesis on a laboratory scale, the conventional synthetic routes via reaction of chlorine gas with carbon monoxide have proven to be too costly and therefore impractical. It was therefore an object of the present invention to provide a process for the formation of phosgene for direct further processing in amounts on a laboratory scale.

In patent application WO 2012/130803 A1, it has been described that specific ionic liquids are suitable as chlorine gas absorbers, which can remove excess chlorine from a crude product of a synthesis in a work-up step of a synthetic process in a rectification column. The absorbed chlorine gas is to be expelled (stripped) by introducing an additional gas, for example carbon monoxide, wherein the gas mixture obtained after the chlorine gas has been expelled, for example a mixture of Cl₂ and carbon monoxide, is to be fed to a classical phosgene synthesis and converted there.

It has now been found that the reaction of carbon monoxide gas with at least one polychlorine anion-containing compound according to the process described below offers a direct preparation method for phosgene which solves the aforementioned problems.

The present invention is therefore a process for preparing phosgene, comprising at least the steps of
a) providing a reaction chamber comprising a component having at least one polychlorine anion-containing compound, preferably at least one polychlorine anion-containing compound in the form of an ionic liquid,
b) bringing carbon monoxide into contact with said component in the reaction chamber and converting the carbon monoxide therein to form a phosgene-containing product.
c) optionally collecting the phosgene from the phosgene-containing product of step b),
d) optionally reacting the phosgene from the phosgene-containing product of step b) or the phosgene collected from step c) with a phosgene-reactive component,
   with the proviso that the phosgene-containing product formed in step b), based on the total weight of which, comprises less than 5.0% by weight Cl₂, preferably less than 3% by weight Cl₂, particularly preferably less than 2% by weight Cl₂.

A “reaction chamber” is a volume in which the co-reactants taking part in a chemical reaction are brought together and in which the chemical reaction takes place. For a chemical reaction with polychlorine anion, for example, this can be the volume of a vessel in which polychlorine anion and the co-reactant thereof, here carbon monoxide, are located together.

A “reaction zone” is the part of the reaction space in which the chemical reaction takes place.

A substance (or a composition) is “liquid” if it is in the liquid state at 20° C. and 1013 mbar. A substance (or a composition) is “solid” if it is in the solid state at 20° C. and 1013 mbar. A substance (or a composition) is “gaseous” if it is present as a gas at 20° C. and 1013 mbar.

A substance is “organic” if its chemical structure comprises at least one covalent carbon-hydrogen bond.

The process according to the invention is carried out in such a way that the polychlorine anion-containing compound and the carbon monoxide are reacted in the reaction chamber to give a phosgene-containing product which, based on the total weight thereof, comprises less than 5% by weight Cl₂. The reaction regime is such that the carbon monoxide introduced into the reaction chamber does not function as a stripping gas, as described in WO 2012/130803 A1, in which chlorine is expelled extensively from the polychlorine anion-containing compound in the reaction chamber, thereby obtaining a gas mixture of carbon monoxide and chlorine and reducing the polychlorine anion concentration in the reaction chamber, but that the carbon monoxide is introduced into the reaction chamber in such a way that the polychlorine anion remains intact in the reaction chamber and does not release chlorine gas, whereby a sufficient amount of polychlorine anion is available for chemical reaction with the carbon monoxide in the reaction chamber and is converted to phosgene (“local conversion”). Preferably, suitable embodiments of steps of this local conversion will be described further below at a later stage.

In the process according to the invention, step a) provides a component comprising at least one polychlorine anion-containing compound. It is preferred if the cation of the polychlorine-containing compound is selected from the group of one or more cations, in each case substituted by different alkyl and/or aryl substituents, selected from ammonium, phosphonium, sulfonium, imidazolium, pyrrolidinium, piperidinium, pyridinium or guanidinium cations or mixtures thereof and the polychlorine anion Cl₍ᵣ₊₂₎⁻ is present, in which r is an odd integer from 1 to 7, preferably 1 or 3. In the context of the present invention, alkyl substitution is in particular substitution by C₁- to C₆-alkyl, preferably C₁ to C₃-substituents (methyl, ethyl, n-propyl and isopropyl substitution); aryl substitution is in particular substitution by C₅- to C₆-aryl substituents. The aryl substituents may optionally comprise various heteroatoms such as oxygen, sulfur, nitrogen, fluorine or chlorine.

Said cation is particularly preferably selected from the group of ammonium cations or phosphonium cations each substituted by different alkyl and/or aryl groups.

Potentially suitable as cations for said polychlorine anion-containing compound of the novel process are the following simple cations, some of which are known from literature, from the list:

1,2,3-trimethylimidazolium, 1,3,4,5-tetramethylimidazolium, 1,3,4-dimethylimidazolium, 1,3,4-trimethylimidazolium, 1,3-dibutyl-2-methylimidazolium, 1,3-dibutylimidazolium, 1,2-dimethylimidazolium, 1,3-dimethylimidazolium, 1-benzyl-3-methylimidazolium, 1-butyl-2,3-dimethylimidazolium, 1-butyl-2-ethyl-5-methylimidazolium, 1-butyl-2-ethylimidazolium, 1-butyl-2-5 methylimidazolium, 1-butyl-3,4,5-trimethylimidazolium, 1-butyl-3,4-dimethylimidazolium, 1-butyl-3-ethylimidazolium, 1-butyl-3-methylimidazolium, 1-butyl-4-methylimidazolium, 1-butylimidazolium, 1-decyl-3-methylimidazolium, 1-dodecyl-3-methylimidazolium, 1-ethyl-2,3-dimethylimidazolium, l-ethyl-3-methylimidazolium, 1-hexadecyl-2,3-dimethylimidazolium, 1-hexadecyl-3-methylimidazolium, 1-hexyl-2,3-dimethylimidazolium, 1-hexyl-3-methylimidazolium, 1-methyl-2-ethylimidazolium, 1-methyl-3-octylimidazolium, 1-methylimidazolium, 1-pentyl-3-methylimidazolium, 1-phenylpropyl-3-methylimidazolium, 1-propyl-2,3-dimethylimidazolium, 1-tetradecyl-3-methylimidazolium, 2,3-dimethylimidazolium, 2-ethyl-3,4-dimethylimidazolium, 3,4-dimethylimidazolium,

trimethylsulfonium, triethylsulfonium, diethylmethylsulfonium, ethyldimethylsulfonium, methyl(diphenyl)sulfonium, ethyl(diphenyl)sulfonium, triphenylsulfonium, tris(4-tert-butylphenyl)sulfonium,

1-butyl-1-methylpyrrolidinium, 1-propyl-1-methylpyrrolidinium, 1-propyl-1-ethylpyrrolidinium, i-ethyl-1-methylpyrrolidinium, 1-diethylpyrrolidinium, 1-dimethylpyrrolidinium,

1-butyl-1-methylpiperidinium, 1-propyl-1-methylpiperidinium, 1-propyl-1-ethylpiperidinium, 1-ethyl-1-methylpiperidinium, 1-diethylpiperidinium, 1-dimethylpiperidinium, 1,2-dimethylpyridinium, 1-butyl-2-ethyl-6-methylpyridinium, 1-butyl-2-ethylpyridinium, 1-butyl-2-methylpyridinium, 1-butyl-3,4-dimethylpyridinium, 1-butyl-3,5-dimethylpyridinium, 1-butyl-3-ethylpyridinium, 1-butyl-3-methylpyridinium, 1-butyl-4-methylpyridinium, 1-butylpyridinium, 1-ethylpyridinium, 1-hexyl-3-methylpyridinium, 1-hexyl-4-methylpyridinium, 1-hexylpyridinium, 1-methylpyridinium, 1-octylpyridinium, 2-ethyl-1,6-dimethylpyridinium, 2-ethyl-1-methylpyridinium, 4-methyl-1-octylpyridinium, 1,1-dimethylpyrrolidinium, 1-butyl-1-ethylpyrrolidinium, 1-butyl-1-methylpyrrolidinium, 1-ethyl-1-methylpyrrolidinium, 1-ethyl-3-methylpyrrolidinium, 1-hexyl-1-methylpyrrolidinium, 1-octyl-1-methylpyrrolidinium, guanidinium, hexamethylguanidinium, N,N,N′,N′-tetramethyl-N″-ethylguanidinium, N-pentamethyl-N-isopropylguanidinium, N-pentamethyl-N-propylguanidinium,

benzyltriphenylphosphonium, tetrabutylphosphonium, trihexyl(tetrndecyl)phosphonium, triisobutyl(methyl)phosphonium,

butyltrimethylammonium, methyltrioctylammonium, octyltrimethylammonium, tetrabutylammonium, tetrapropylammonium, tetraethylammonium, tetramethylammonium and/or tributylmethylammonium.

In the context of one embodiment of the invention, the component of step a) comprises at least one polychlorine anion-containing compound of the formula (III) or the formula (IV) or a mixture thereof,

N—R¹ₘR²ₙR³ₒ⁺Cl₍ᵣ₊₂₎⁻ (III)

P—R⁴ₚR⁵_{q}⁺Cl₍ₛ₊₂₎⁻ (IV)

in which
the radicals R¹, R², R³, R⁴ and R⁵ are each independently identical or different alkyl radicals selected from the group of: methyl, ethyl, n-propyl, isopropyl, n-butyl, isobutyl and 2-methylpropyl, preferably methyl, ethyl, or n-propyl,
with the proviso that at least one radical of R¹, R² or R³ is different from the other respective radicals R¹, R² and R³ and the radicals R⁴ and R⁵ are different from each other,
m, n, o, p, and q are each independently an integer in the series from 0 to 4 and where the sum of m+n+o and the sum of p+q must result in the value 4,
where r and s are each independently an odd integer from 1 to 7, preferably r and s are each independently 1 or 3.

It has been found to be particularly advantageous if, in accordance with the compound of the general formula (III), m and n are a number 1, 2 or 3, and o is 0.

It has been found to be particularly suitable for the process according to the invention if the compound of the formula (III) or (IV) is selected from at least one compound from the series: NEtMe₃Cl₍ᵣ₊₂₎, NEt₂Me₂Cl₍ᵣ₊₂₎, NEt₃MeCl₍ᵣ₊₂₎, NBuEt₂MeCl₍ᵣ₊₂₎, NMePr₃Cl₍ᵣ₊₂₎, NBu₂Me₂Cl₍ᵣ₊₂₎, PEt₃MeCl₍ᵣ₊₂₎, where the abbreviations Me, Et, Pr, Bu are methyl, ethyl, n-propyl and n-butyl, in which r is an odd integer from 1 to 7, preferably 1 or 3.

It is also particularly preferred in turn to select the compound of the formula (III) from at least one compound of the series: NEtMe₃Cl₍ᵣ₊₂₎, NEt₂Me₂Cl₍ᵣ₊₂₎, NEt₃MeCl₍ᵣ₊₂₎, r is an odd integer from 1 to 7, preferably 1 or 3.

The polychlorine anion-containing compound of said component of the process according to the invention is effectively obtained by reacting chlorine (Cl₂) with at least one ionic organic compound, wherein the cation of the ionic organic compound is selected from the group of one or more each differently alkyl- and/or aryl-substituted cations selected from ammonium, phosphonium, sulfonium, imidazolium, pyridinium or guanidinium cations or mixtures thereof (preferably from the group of differently alkyl- and/or aryl-substituted ammonium cations or phosphonium cations) and the anion of the ionic organic compound is monochloride.

In the context of one embodiment of the novel process, the polychlorine anion-containing compound is obtained by reacting chlorine (Cl₂) with at least one ionic organic compound of the general formula (I) and/or (II),

N—R¹ₘR²ₙR³ₒ⁺Cl⁻ (I)

P—R⁴ₚR⁵_{q}⁺Cl⁻, (II)

preferably an ionic compound of general formula (I),
in which formulae (I) and (II), the radicals R¹, R², R³, R⁴ and R⁵, each independently the same or different, are an alkyl radical selected from the group: methyl, ethyl, n-propyl, isopropyl, n-butyl, isobutyl and 2-methylpropyl, preferably methyl, ethyl, isopropyl or n-propyl, but restrictively at least one radical R¹, R² or R³ is different from the other respective radicals R¹, R² and R³ and the radicals R⁴ and R⁵ are different from each other,
where the characters m, n, o, p, and q are each independently an integer in the series from 0 to 3 and where the sum m+n+o and the sum p+q must result in a value of 4.

Particularly preferably, in the compound of general formula (I), the characters m and n are 1, 2 or 3 and o is 0.

At least one ionic organic compound is particularly preferably used, from at least one compound of the series: NEtMe₃Cl, NEt₂Me₂Cl, NEt₃MeCl, NMePr₃Cl, PEt₃MeCl.

To provide the polychlorine anion-containing compound, the compound (I) is especially preferably selected from at least one compound of the series: NEtMe₃Cl, NEt₂Me₂Cl, NEt₃MeCl.

In the process according to the invention, liquid components (at 1013 mbar and 20° C.) comprising at least one polychlorine anion-containing compound are preferably used in step a). It is particularly preferred if the polychlorine anion-containing compound is an ionic liquid.

A further possibility for providing a liquid component of step a) is the use of liquid, organic solvents as a liquid composition, in which said polychlorine anion-containing compound can be incorporated, to obtain a solution or dispersion.

Also preferably, as a component of step a), at least one polychlorine anion-containing compound in the form of an ionic liquid and additionally a further liquid composition in contact therewith in the form of a liquid phase can be provided in the reaction chamber. According to the invention, a “phase” is understood to mean a substance or substance mixture which is in contact with another substance or substance mixture and forms a phase boundary. A phase boundary is a term for surfaces that separate two phases that are not mixed with each other; for example, the separating surfaces between the liquid-solid, liquid-liquid, solid-solid, solid-gas, or liquid-gas phases. Further embodiments of corresponding steps of the process according to the invention, in which liquid compositions containing organic solvents act as solvents for said polychlorine anion-containing compound of component of step a) or as a separate liquid phase thereof, are described in more detail later.

In step b) of the process according to the invention, the component of step a) is brought into contact with carbon monoxide and reacted in the reaction chamber to give a phosgene-containing product.

The reaction with carbon monoxide in step b) proceeds particularly effectively if the component of step a), based on the total weight thereof, comprises at least 50% by weight compounds having a polychlorine anion. Therefore, said component of step a), based on the total weight of this component, preferably comprises at least 50% by weight, preferably at least 75% by weight, especially preferably at least 90% by weight, compounds having polychlorine anions.

For the reaction of the carbon monoxide to form a phosgene-containing product according to step b) of the process according to the invention, it proved to be particularly suitable if the molar ratio of the total amount of carbon monoxide provided for the reaction in step b) to the polychlorine anion-containing compound provided in step a) (i.e. amount of carbon monoxide divided by amount of polychlorine anion-containing compound provided in a)) is at least 1, preferably greater than 1, particularly preferably greater than 1.25, especially preferably greater than 1.5. For the reaction of the carbon monoxide to form a phosgene-containing product according to step b) of the process according to the invention, it proved to be particularly suitable if the molar ratio of the total amount of carbon monoxide provided for the reaction in step b) to the polychlorine anion-containing compound provided in step a) is at most 100, preferably at most 50, particularly preferably at most 25, very particularly preferably at most 10, most preferably at most 5. A range of 1 to 100, preferably of greater than 1 to 100, particularly preferably of greater than 1 to 50, more preferably of greater than 1 to 25, more preferably of greater than 1 to 10, more preferably of greater than 1 to 5, especially preferably of greater than 1.25 to 50, more preferably of 1.25 to 25, more preferably of 1.25 to 10, more preferably of 1.25 to 5, even more preferably of greater than 1.5 to 25, more preferably of greater than 1.5 to 10, most preferably of greater than 1.5 to 5, are in each case particularly suitable for said molar ratio of the total amount of carbon monoxide provided and polychlorine anion-containing compound used, provided for the reaction in step b).

Usually, phosgene production by means of classical phosgene synthesis requires temperatures of up to 500° C. to provide the necessary energy. It has been shown for the process according to the invention that the energy to be expended for the reaction is lower. Thus, in a preferred embodiment of the invention, step b) is carried out at temperatures

<500° C., preferably <250° C., more preferably <150° C., particularly preferably <100° C., more preferably <80° C., especially preferably <50° C., most preferably <30° C.

The introduction of the carbon monoxide into the reaction chamber according to step b) can be carried out by directly introducing the gaseous carbon monoxide into said component having at least one polychlorine anion-containing compound, for example via a nozzle or a tube or a frit. The gaseous carbon monoxide can also be introduced into the reaction chamber as a gaseous phase without passing through said component. In both cases, a composition containing at least one polychlorine anion-containing compound in a liquid phase and a gaseous phase containing carbon monoxide and phosgene in contact with the liquid phase, is formed in the reaction chamber during the course of the reaction.

In the context of one embodiment of the invention, step b) can be carried out in such a way that the amount of carbon monoxide provided for the reaction is fed into the reaction chamber in such a way that an increase in pressure is caused in the reaction chamber. Consequently, one embodiment of the process according to the invention provides that in step b) the carbon monoxide is introduced into the reaction chamber so that the internal pressure of the reaction chamber is higher than atmospheric pressure, and the carbon monoxide is brought into contact with said component. It is also advantageous to select the contact time of the carbon monoxide with said component accordingly until a pressure drop in the reaction chamber can no longer be registered.

A further embodiment of the process according to the invention provides that the amount of gaseous carbon monoxide provided for the reaction therein is introduced into the reaction chamber and introduced directly into said component having at least one polychlorine anion-containing compound, wherein the gaseous carbon monoxide-containing phase present in the reaction chamber is circulated and repeatedly introduced into said component.

Likewise, for a reaction therein, a stream of gaseous carbon monoxide can be introduced into the reaction chamber and brought into contact with said component having at least one polychlorine anion-containing compound, and residual gas can be discharged from the reaction chamber without being recirculated to the reaction chamber, it being preferred in this flow of gaseous carbon monoxide through the reaction chamber if the phosgene-containing product formed in step b) either remains in the reaction chamber or is collected after discharge in step c).

In general, the process according to the invention may provide for the phosgene-containing product formed in step b) to remain in the reaction chamber or for the phosgene-containing product to be discharged from the reaction chamber.

In the case that the phosgene-containing product remains in the reaction chamber, one embodiment of the process according to the invention is characterized in that the phosgene-containing product formed in step b) passes into the gas phase and remains in the reaction chamber during the conversion of the carbon monoxide on said component.

A further embodiment of the process according to the invention can provide for a transition of the phosgene-containing product into the gas phase, in which case this phosgene-containing product in the gas phase is then removed from the reaction chamber and collected outside the reaction chamber, for example by condensation of the phosgene or by dissolving the phosgene in a liquid composition containing liquid solvent, for example an organic solvent such as toluene, 1,2-dichlorobenzene, 1,4-dichlorobenzene, monochlorobenzene, fluorobenzene, 1,2-difluorobenzene, dichloromethane or mixtures thereof. A preferred process according to the invention is thus characterized in that the phosgene-containing product formed in step b) is removed from the reaction chamber and the phosgene formed in step b) contained therein is collected outside the reaction chamber in step c), preferably by condensation or by dissolving in an organic solvent.

However, it is equally the case according to the invention in which the phosgene-containing product remains in the reaction chamber and is taken up there in a liquid composition containing organic solvent. Thus, a process according to the invention is preferred in which the phosgene of the phosgene-containing product formed in step b) is dissolved in step c) in a liquid composition containing organic solvent and thereby collected, said liquid composition being in the reaction chamber. It is advantageous if said liquid composition is already in the reaction chamber during the reaction in step b) and is in contact with the component containing at least one polychlorine anion-containing compound. The liquid composition can form a phase boundary with the component from step a) or the component from step a) is dissolved therein. In order to reduce evaporation of the phosgene formed and to increase retention of the phosgene in the liquid composition, said liquid organic composition may be cooled to 0 to 10° C.

The phosgene-containing product formed in the reaction in step b) can pass directly into the organic solvent-containing liquid composition (optionally in the form of a liquid phase) and be collected. One embodiment of the method according to the invention is consequently characterized in that at least one organic solvent is present in the liquid composition (especially in the liquid phase), in which phosgene dissolves at 20° C. and 1013 mbar to an extent of at least 1 g/L, preferably dissolves to an extent of at least 100 g/L, particularly preferably dissolves to an extent of at least 250 g/L.

Consequently, preference is therefore given to a process according to the invention in which in step b), in addition to said component comprising at least one polychlorine anion-containing compound, a liquid phase containing organic solvent is additionally present in the reaction chamber, said liquid phase being in contact with said component. This liquid phase can already be provided together with said component comprising polychlorine anion-containing compound from step a) in step a), with the formation of two phases. In the context of this embodiment, the choice of solvent is such that the amount of polychlorine anion-containing compound used does not dissolve completely in the organic solvent. For this purpose, it proved advantageous to select said liquid phase such that the polychlorine anion-containing compound dissolves therein, at 20° C. and 1013 mbar, to an extent of less than 0.1 g/L, in particular to an extent of less than 0.01 g/L.

Prior to the reaction with carbon monoxide, said liquid composition used in step b) (in particular the liquid phase used in step b)), based on the total weight thereof, preferably comprises a total amount of at least 50% by weight, preferably at least 75% by weight, especially preferably at least 90% by weight organic solvent. Liquid compositions containing the organic solvent which does not react chemically with polychlorine anion-containing compounds, especially under the reaction conditions selected in the process according to the invention (e.g. with respect to pressure and temperature), i.e. a solvent which is inert to polychlorine anion-containing compounds, have proven to be particularly suitable. It has therefore proven to be preferable if said organic solvent is aprotic. An “aprotic solvent” is understood by those skilled in the art to mean those liquid, organic compounds as such having low E_{T}^{N} values (0.0-0.4; E_{T}^{N}=normalized values of the empirical solvent polarity parameters as defined in: Reichardt, C., Solvents and Solvent Effects in Organic Chemistry, 3rd edition; Wiley VCH: Weinheim, (2003).

Particularly preferred organic solvents are selected from aprotic, organic compounds comprising at least one halogen atom selected from chlorine and fluorine, in particular 1,2-dichlorobenzene, 1,4-dichlorobenzene, monochlorobenzene, fluorobenzene, 1,2-difluorobenzene, dichloromethane or mixtures thereof.

It is preferred according to the invention if, in step a) of the process according to the invention, a mixture of at least one polychlorine anion-containing compound and at least one organic solvent is initially charged in the reaction chamber, in which based on the total weight of all polychlorine anion-containing compounds and all organic solvents, comprises organic solvent in a total amount of at most 50% by weight, particularly preferably at most 45% by weight, more preferably at most 40% by weight.

When the polychlorine anion-containing compound is reacted therein with carbon monoxide, a monochlorine anion-containing compound is formed, inter alia, in particular at least one ionic organic compound selected from the aforementioned general formula (I) or (II). In order to ensure a particularly good separation of this monochlorine anion-containing compound from the product mixture, it has been found to be particularly suitable to use in steps a) and b) such a liquid composition containing at least one organic solvent in which the ionic organic compound NMeEt₃Cl dissolves, at 20° C. and 1013 mbar, to an extent of less than 0.1 g/L, in particular to an extent of less than 0.05 g/L. The monochlorine anion-containing compound which has been separated off can be reacted again with Cl₂ as described above, to provide said polychlorine anion-containing compound.

The phosgene of the phosgene-containing product formed in step b) obtained by the process according to the invention in said reaction chamber may be reacted with at least one phosgene-reactive component in said reaction chamber. It is preferred if the phosgene-reactive component is an organic compound, preferably at least one organic alcohol or at least one organic amine, in particular at least one organic compound having at least two hydroxyl groups or at least one organic compound having at least two amino groups, particularly preferably at least one organic diol or at least one organic diamine.

In carrying out step b) of the process according to the invention, a composition having two or more phases is used in the reaction chamber, which is also an object of this invention. The composition present in step b) in the reaction chamber is a composition having at least two phases comprising a gas containing carbon monoxide as the first phase, and at least one polychlorine anion-containing component as a further phase different therefrom, preferably in the form of an ionic liquid. The polychlorine anion-containing component is a component comprising a polychlorine anion-containing compound.

With increasing reaction time, there is an increase in the phosgene content, in particular in the first phase, so that a composition preferred according to the invention is characterized in that it comprises at least two phases containing, as the first phase, a gas comprising carbon monoxide, phosgene and, based on the weight of the phase, less than 5% by weight chlorine, preferably less than 3% by weight, particularly preferably less than 2% by weight, and, as a phase different therefrom, at least one monochlorine anion-containing component.

In the context of one embodiment, if at least one organic solvent is used in step b) of the process according to the invention, this at least one organic solvent may be part of the aforementioned further phase (for example polychlorine anion-containing component dissolves in the at least one organic solvent) or forms a separate liquid phase. Particularly suitable is a composition having at least two phases, comprising gaseous carbon monoxide as the first phase, and at least one polychlorine anion-containing component as a phase different therefrom, preferably in the form of an ionic liquid, characterized in that the composition additionally comprises at least one organic solvent.

In particular, as the reaction proceeds in step b) of the process according to the invention, a composition is obtained in the reaction zone comprising phosgene, at least one ionic, organic monochlorine anion-containing compound and at least one organic solvent. The phosgene present in the composition is preferably present dissolved in the at least one organic solvent, wherein the at least one ionic, organic monochlorine anion-containing compound is at least partially dissolved in the at least one organic solvent. It is in turn particularly preferred if the phosgene present in the composition is present dissolved in the at least one organic solvent and forms a liquid phase, wherein the at least one ionic, organic monochlorine anion-containing compound is present at least partially as a solid phase.

Embodiments of features of the method, which are also features of the composition, and preferred configurations thereof, are also embodiments or preferred configurations of the composition, in particular with regard to the features of the polychlorine anion-containing component (polychlorine anion-containing compound), the solvent, the ionic organic monochlorine anion-containing compound.

The following aspects 1 to 26 illustrate the invention without restricting it thereto:
1. A process for producing phosgene, comprising at least the steps of
   a) providing a reaction chamber comprising a component having at least one polychlorine anion-containing compound, preferably at least one polychlorine anion-containing compound in the form of an ionic liquid,
   b) bringing carbon monoxide into contact with said component in the reaction chamber and converting the carbon monoxide therein to form a phosgene-containing product.
   c) optionally collecting the phosgene from the phosgene-containing product of step b),
   d) optionally reacting the phosgene from the phosgene-containing product of step b) or the phosgene collected from step c) with a phosgene-reactive component.
   with the proviso that the phosgene-containing product formed in step b), based on the total weight of which, comprises less than 5.0% by weight Cl₂, preferably less than 3.0% by weight Cl₂, particularly preferably less than 2.0% by weight Cl₂.
2. The process according to aspect 1, characterized in that said component from step a) comprises at least one polychlorine anion-containing compound, wherein the cation of which is selected from the group of one or more each differently alkyl- and/or aryl-substituted cations selected from ammonium, phosphonium, sulfonium, imidazolium, pyridinium or guanidinium cations or mixtures thereof (preferably from the group of each differently alkyl- and/or aryl-substituted ammonium cations or phosphonium cations) and the polychlorine anion present is Cl₍ᵣ₊₂₎⁻, in which r is an odd integer from 1 to 7, preferably 1 or 3.
3. The process according to either of the preceding aspects, characterized in that the component from step a) comprises at least one polychlorine anion-containing compound of the formula (III) or the formula (IV) or a mixture thereof,

N—R¹ₘR²ₙR³ₒ⁺Cl₍ᵣ₊₂₎⁻ (III)

P—R⁴ₚR⁵_{q}⁺Cl₍ₛ₊₂₎⁻ (IV)
in which
the radicals R¹, R², R³, R⁴ and R⁵ are each independently identical or different alkyl radicals selected from the group of: methyl, ethyl, n-propyl, isopropyl, n-butyl, isobutyl and 2-methylpropyl, preferably methyl, ethyl, or n-propyl,
   with the proviso that at least one radical of R¹, R² or R³ is different from the other respective radicals R¹, R² and R³ and the radicals R⁴ and R⁵ are different from each other,
m, n, o, p, and q are each independently an integer in the series from 0 to 3 and where the sum of m+n+o and the sum of p+q must result in the value 4,
where r and s are each independently an odd integer from 1 to 7, preferably r and s are each independently 1 or 3.
4. The process according to aspect 3, characterized in that, in accordance with the compound of the general formula (III), m and n are a number 1, 2 or 3, and o is 0.
5. The process according to aspect 3, characterized in that the compound of the formula (III) or (IV) is selected from at least one compound of the series: NEtMe₃Cl₍ᵣ₊₂₎, NEt₂Me₂Cl₍ᵣ₊₂₎, NEt₃MeCl₍ᵣ₊₂₎, NBuEt₂MeCl₍ᵣ₊₂₎, NMePr₃Cl₍ᵣ₊₂₎, NBu₂Me₂Cl₍ᵣ₊₂₎, PEt₃MeCl₍ᵣ₊₂₎, where the abbreviations Me, Et, Pr, Bu are methyl, ethyl, n-propyl and n-butyl, where r has the meaning defined in claim 3.
6. The process according to aspect 3, characterized in that the compound of the formula (III) is selected in particular from at least one compound of the series: NEtMe₃Cl₍ᵣ₊₂₎, NEt₂Me₂Cl₍ᵣ₊₂₎, NEt₃MeCl₍ᵣ₊₂₎, where r has the meaning defined in claim 3.
7. The process according to aspects 2 to 6, characterized in that the polychlorine anion-containing compound is obtained by reacting chlorine (Cl₂) with at least one ionic organic compound, wherein the cation of the ionic organic compound is selected from the group of one or more each differently alkyl- and/or aryl-substituted cations selected from ammonium, phosphonium, sulfonium, imidazolium, pyridinium or guanidinium cations or mixtures thereof (preferably from the group of differently alkyl- and/or aryl-substituted ammonium cations or phosphonium cations) and the anion of the ionic organic compound is monochloride.
8. The process according to any of the preceding aspects, wherein said component of step a), based on the total weight of this component, comprises at least 50% by weight, preferably at least 75% by weight, especially preferably at least 90% by weight of compounds having polychlorine anions.
9. The process according to any of the preceding aspects, characterized in that the molar ratio of the total amount of carbon monoxide provided for the reaction in step b) to the polychlorine anion-containing compound provided in step a) (i.e. amount of carbon monoxide divided by amount of polychlorine anion-containing compound used) is at least 1, preferably greater than 1, particularly preferably greater than 1.25, especially preferably greater than 1.5.
10. The process according to any of the preceding aspects, characterized in that the molar ratio of the total amount of carbon monoxide provided for the reaction in step b) to the polychlorine anion-containing compound provided in step a) is at most 100, preferably at most 50, particularly preferably at most 25, especially preferably at most 10, most preferably at most 5.
11. The process according to any of the preceding aspects, characterized in that step b) is carried out at temperatures <500° C., preferably <250° C., more preferably <150° C., particularly preferably at <100° C., more preferably <80° C., especially preferably <50° C., most preferably <30° C.
12. The process according to any of the preceding aspects, characterized in that the liquid component of step a) additionally comprises at least one liquid organic solvent as a liquid composition, in which said polychlorine anion-containing compound can be incorporated, to obtain a solution or dispersion.
13. The process according to any of the preceding aspects, characterized in that the carbon monoxide is introduced into the reaction chamber in step b) so that the internal pressure of the reaction chamber is higher than atmospheric pressure, and the carbon monoxide is brought into contact with said component.
14. The process according to any of the preceding aspects, characterized in that step d) is carried out and the phosgene of the phosgene-containing product formed in step b) is reacted with at least one phosgene-reactive component in said reaction chamber.
15. The process according to aspect 14, characterized in that the phosgene-reactive component is an organic compound, preferably at least one organic alcohol or at least one organic amine, in particular at least one organic compound having at least two hydroxyl groups or at least one organic compound having at least two amino groups, particularly preferably at least one organic diol or at least one organic diamine.
16. The process according to any of the preceding aspects, characterized in that the phosgene-containing product formed in step b) passes into the gas phase and remains on said component in the reaction chamber during the conversion of the carbon monoxide.
17. The process according to any of the preceding aspects, characterized in that the phosgene-containing product formed in step b) is removed from the reaction chamber and the phosgene present therein formed in step b) is collected outside the reaction chamber in step c), preferably by condensation or by dissolving in a liquid composition containing organic solvent.
18. The process according to any of the preceding aspects, characterized in that the phosgene of the phosgene-containing product formed in step b) is dissolved in a liquid composition containing organic solvent in step c) and thereby collected, wherein said liquid composition is in the reaction chamber.
19. The process according to any of aspects 1 to 18, characterized in that a liquid composition in the form of a liquid phase containing organic solvent is present in the reaction chamber in addition to said component, wherein said liquid phase is in contact with said component.
20. The process according to any of aspects 12, 17 to 19, characterized in that said liquid composition, based on the total weight thereof, comprises a total amount of at least 50% by weight, preferably at least 75% by weight, especially preferably at least 90% by weight organic solvent.
21. The process according to any of aspects 12, 17 to 20, characterized in that present in the liquid composition is at least one aprotic organic solvent selected from 1,2-dichlorobenzene, 1,4-dichlorobenzene, monochlorobenzene, fluorobenzene, 1,2-difluorobenzene, Dichloromethane or mixtures thereof.
22. The process according to any of aspects 12, 17 to 21, characterized in that at least one organic solvent is present in the liquid composition, in which phosgene dissolves at 20° C. and 1013 mbar to an extent of at least 1 g/L, preferably to an extent of at least 100 g/L, particularly preferably to an extent of at least 250 g/L.
23. The process according to any of aspects 12, 18 to 22, characterized in that said liquid composition is selected such that the polychlorine anion-containing compound dissolves therein, at 20° C. and 1013 mbar, to an extent of less than 0.1 g/L, in particular to an extent of less than 0.01 g/L.
24. The process according to any of aspects 12, 17 to 23, characterized in that said liquid composition is selected such that the ionic organic compound NMeEt₃Cl dissolves therein, at 20° C. and 1013 mbar, to an extent of less than 0.1 g/L, in particular to an extent of less than 0.05 g/L.
25. A composition having at least two phases, comprising gaseous carbon monoxide as the first phase, and at least one polychlorine anion-containing component as a phase different therefrom, preferably in the form of an ionic liquid, characterized in that the composition additionally comprises at least one organic solvent.
26. The composition according to aspect 25, characterized in that said organic solvent is present as a further additional phase in the form of at least one liquid phase.
27. The composition having at least one phase containing phosgene, at least one ionic, organic monochlorine anion-containing compound and at least one organic solvent.

### EXAMPLES

Synthesis of Phosgene from [NEt₃Me][Cl₃₋₇] and Organic Solvent Containing CO

o-Dichlorobenzene (oDCB, 20 mL) and [NEt₃Me][Clₓ] (x=3-7, x(averaged)=3.95, 3.90 g, 15.3 mmol) were initially charged in a reactor equipped with a diffuser and a drain cock. The reactor was connected to a peristaltic pump and an IR and UV/Vis spectrometer to form a circuit. The system was flushed with excess CO (32 mmol). The gas phase was pumped through the system of oDCB and [NEt₃Me][Clₓ] for up to 7 hours and the gas phase is characterized every 5 minutes by IR and UV/Vis spectroscopy. In the IR spectra, the formation of phosgene was observed, evident from the steady decrease in the characteristic absorption band of CO at 2171 cm⁻¹ and the increase in the absorption band characteristic of phosgene at 1682 cm⁻¹. This is consistent with the steady decrease in the characteristic absorption band for Cl₂ observed in the UV/Vis spectrum at 330 nm and the increase in the absorption band of phosgene at 231 nm. An oDCB phase was then transferred to a reaction vessel via the drain cock. The presence of the phosgene formed in the gas phase of the reaction vessel containing oDCB was confirmed by IR spectroscopy. In the IR spectrum, only the bands characteristic of phosgene were observed at v=3632 (vw) cm⁻¹, 1826 (s) cm⁻¹, 1626 (w) cm⁻¹, 1409 (vw) cm⁻¹, 1107 (w) cm⁻¹, 851 (vs) cm⁻¹ and 571 (w) cm⁻¹. The phosgene-containing oDCB solution can now be used directly for phosgenation reactions—in particular for the phosgenation of amines and alcohols to form isocyanates and carbonates.

Synthesis of Phosgene from [NEt₃Me][CLv7] and CO

[NEt₃Me][Clₓ] (x=3-7, x(averaged)=3.9, 3.8 g, 15.0 mmol) was filled into a reactor and the gas phase thereof with CO (0.171 mg, 6.0 mmol). The reaction was then stirred at 35° C. for 4 days to react the CO with [NEt₃Me][Clₓ] to give phosgene. The formation of phosgene was clearly demonstrated by IR spectroscopy after completion of the reaction (v=3632 (vw) cm⁻¹, 1826 (s) cm⁻¹, 1626 (w) cm⁻¹, 1409 (vw) cm⁻¹, 1107 (w) cm⁻¹, 851 (vs) cm⁻¹ and 571 (w) cm⁻¹; conversion≈96% based on the amount of CO used). The phosgene can now be used directly for phosgenation reactions—in particular for the phosgenation of amines and alcohols to form isocyanates and carbonates.

Synthesis of Phenyl Isocyanate from [NEt₃Me][Cl₃₋₇], CO and Phenylamine

An excess of CO was introduced into a mixture of o-dichlorobenzene (20 mL) and [NEt₃Me][Clₓ] (x=3-7, x(averaged)=˜3.2, ˜0.57 g, 2.42 mmol). The reaction mixture was stirred at room temperature until the [NEt₃Me][Clₓ] was fully converted. The resulting suspension was cooled to −15° C., to which aniline (0.51 g, 5.48 mmol) in o-dichlorobenzene (5 mL) was added dropwise, and stirred at 100° C. for 8 hours. The reaction product was examined by means of IR spectroscopy and showed the band characteristic of phenyl isocyanate at v=2273 cm⁻¹.

1. A process for producing phosgene, comprising:
a) providing a reaction chamber comprising a component having at least one polychlorine anion-containing compound,
b) bringing carbon monoxide into contact with said component in the reaction chamber and converting the carbon monoxide therein to form a phosgene-containing product,
c) optionally collecting the phosgene from the phosgene-containing product of step b),
d) optionally reacting the phosgene from the phosgene-containing product of step b) or the phosgene collected from step c) with a phosgene-reactive component,
with the proviso that the phosgene-containing product formed in step b) comprises less than 5.0% by weight Cl₂, based on the total weight of the phosgene-containing product formed in step b).

2. The process as claimed in claim 1, wherein said component from step a) comprises at least one polychlorine anion-containing compound, wherein the cation of which is selected from the group of one or more each differently alkyl- and/or aryl-substituted cations selected from ammonium, phosphonium, sulfonium, imidazolium, pyridinium or guanidinium cations or mixtures thereof and the polychlorine anion present is Cl₍ᵣ₊₂₎⁻, in which r is an odd integer from 1 to 7.

3. The process as claimed in claim 1, wherein the component from step a) comprises at least one polychlorine anion-containing compound of the formula (III) or the formula (IV) or a mixture thereof,
N—R¹ₘR²ₙR³ₒ⁺Cl₍ᵣ₊₂₎⁻ (III)
P—R⁴ₚR⁵_{q}⁺Cl₍ₛ₊₂₎⁻ (IV)
in which
the radicals R¹, R², R³, R⁴ and R⁵ are each independently identical or different alkyl radicals selected from the group of: methyl, ethyl, n-propyl, isopropyl, n-butyl, isobutyl and 2-methylpropyl, with the proviso that at least one radical of R¹, R² or R³ is different from the other respective radicals R¹, R² and R³ and the radicals R⁴ and R⁵ are different from each other,
m, n, o, p, and q are each independently an integer in the series from 0 to 3 and where the sum of m+n+o and the sum of p+q equals 4, and
where r and s are each independently an odd integer from 1 to 7.

4. The process as claimed in claim 3, wherein the compound of the formula (III) or (IV) is selected from at least one compound of the series: NEtMe₃Cl₍ᵣ₊₂₎, NEt₂Me₂Cl₍ᵣ₊₂₎, NEt₃MeCl₍ᵣ₊₂₎, NBuEt₂MeCl₍ᵣ₊₂₎, NMePr₃Cl₍ᵣ₊₂₎, NBu₂Me₂Cl₍ᵣ₊₂₎, and PEt₃MeCl₍ᵣ₊₂₎, where Me is methyl, Et is ethyl, Pr is n-propyl, and Bu is n-butyl.

5. The process as claimed in claim 1, wherein said component of step a), based on the total weight thereof, comprises at least 50% by weight of compounds having polychlorine anions.

6. The process as claimed in claim 1, wherein the molar ratio of the total amount of carbon monoxide provided for the reaction in step b) to the polychlorine anion-containing compound provided in step a) is at least 1.

7. The process as claimed in claim 1, wherein the molar ratio of the total amount of carbon monoxide provided for the reaction in step b) to the polychlorine anion-containing compound provided in step a) is at most 100.

8. The process as claimed claim 1, wherein step b) is carried out at a temperature of <500° C.

9. The process as claimed in claim 1, wherein the liquid component of step a) additionally comprises at least one liquid organic solvent as a liquid composition, in which said polychlorine anion-containing compound is incorporated, to obtain a solution or dispersion.

10. The process as claimed in claim 1, wherein the carbon monoxide is introduced into the reaction chamber in step b) so that the internal pressure of the reaction chamber is higher than atmospheric pressure, and the carbon monoxide is brought into contact with said component.

11. The process as claimed in claim 1, wherein step d) is carried out and the phosgene of the phosgene-containing product formed in step b) is reacted with at least one phosgene-reactive component in said reaction chamber.

12. The process as claimed in claim 1, wherein the phosgene-containing product formed in step b) passes into the gas phase and remains on said component in the reaction chamber during the conversion of the carbon monoxide.

13. The process as claimed in claim 1, wherein the phosgene-containing product formed in step b) is removed from the reaction chamber and the phosgene present therein formed in step b) is collected outside the reaction chamber in step c).

14. The process as claimed in claim 1, wherein the phosgene of the phosgene-containing product formed in step b) is dissolved in a liquid composition containing organic solvent in step c) and thereby collected, wherein said liquid composition is in the reaction chamber.

15. The process as claimed in claim 1, wherein a liquid composition in the form of a liquid phase containing organic solvent is present in the reaction chamber in addition to said component, wherein said liquid phase is in contact with said component.

16. The process as claimed in claim 9, wherein said liquid composition, based on the total weight thereof, comprises a total amount of at least 50% by weight organic solvent.

17. The process as claimed in claim 9, wherein at least one organic solvent is present in the liquid composition, in which phosgene dissolves at 20° C. and 1013 mbar to an extent of at least 1 g/L.

18. A composition having at least two phases, comprising gaseous carbon monoxide as the first phase, and at least one polychlorine anion-containing component as a phase different therefrom, characterized in that the composition additionally comprises at least one organic solvent.

19. A composition having at least one phase containing phosgene, at least one ionic, organic monochlorine anion-containing compound and at least one organic solvent.
